(19) United States
(12) Patent Application Publication
(10) Pub. No.: US 2026/0131617 A1
(43) Pub. Date: May 14, 2026

(54) HEATING, VENTILATION, AIR CONDITIONING DEVICE

(71) Applicant: VALEO SYSTEMES THERMIQUES, La Verriere (FR)

(72) Inventors: Jason KREUCHER, Auburn Hills, MI (US); Philippe PIERRES, La Verriere (FR); Thierry BARBIER, La Verriere (FR)

(73) Assignee: VALEO SYSTEMES THERMIQUES, La Verriere (FR)

(21) Appl. No.: 18/947,695

(22) Filed: Nov. 14, 2024

(51) Int. Cl. B60H 1/00

(52) U.S. Cl. CPC B60H 1/00064; B60H 2001/00092; B60H 2001/00135; B60H 2001/00164

(57) ABSTRACT

An HVAC device including: a fresh air inlet, a recirculation air inlet, a blower with an inlet portion and an outlet portion, a recirculation air duct, a fresh air duct separated from the recirculation air duct, a first heat exchanger, a second heat exchanger, both arranged partially in the recirculation air duct and the fresh air duct, wherein the fresh air duct includes a cabin outlet mouth leading to a cabin panel nozzle and a defrost outlet mouth leading to a defrost nozzle, wherein the recirculation air duct includes a floor outlet mouth leading to a floor nozzle, wherein the HVAC device is intended to be mounted in a vehicle so that the recirculation air duct is arranged above the fresh air duct at the outlet portion of the blower.

### TECHNICAL FIELD

The invention relates to a housing for a heating, ventilation and/or air conditioning device of a motor vehicle. The invention also relates to the heating, ventilation and/or air conditioning device for a motor vehicle comprising such a housing, as well as to a vehicle comprising such a heating, ventilation and/or air conditioning device.

### BACKGROUND OF THE INVENTION

Motor vehicles are currently equipped with a ventilation, heating and/or air conditioning device for regulating the aerothermal parameters of an air flow distributed toward the inside of the cabin of the vehicle. The device generally comprises a housing demarcated by partitions, in which openings are provided, including at least one air inlet and at least one air outlet. The housing houses an air blower for circulating the air flow from the air inlet to the air outlet. The housing also houses thermal treatment means for heating and/or cooling the air flow prior to its distribution inside the cabin, with this being based on a command set by an occupant of the vehicle. By way of an example, the thermal treatment means, i.e. the heat exchangers, can comprise an evaporator, which is intended to cool and dehumidify the air flow passing therethrough, as well as a radiator, optionally connected to an additional electric radiator, which is intended to heat any air flow that would pass therethrough. Such a housing also comprises a distribution system channeling the air flow into various zones of the cabin, in particular a zone disposed in the vicinity of a windshield of the vehicle and a lower zone, a median zone or an upper zone of the cabin of the vehicle.

The housing of the heating, ventilation and/or air conditioning installation can be installed in the cabin, between a dashboard of the vehicle and a wall separating the cabin and a front compartment of the vehicle.

### SUMMARY OF THE INVENTION

An object of the invention is a heating, ventilation, air conditioning device comprising: a fresh air inlet, a recirculation air inlet, a first air circulation channel, a second air circulation channel separated from the first air circulation channel, the first air circulation channel being configured to receive air from the fresh air inlet, and the second air circulation channel being configured to receive air from the recirculation air inlet, a blower with an inlet portion and an outlet portion, configured to induce airflow to and from the first air circulation channel and the second air circulation channel so that the fresh air and the recirculation air travel through the blower from the inlet portion to the outlet portion, a recirculation air duct connected to the second circulation channel, a fresh air duct separated from the recirculation air duct and connected to the first circulation channel, a first heat exchanger, a second heat exchanger, with both the first heat exchanger and the second heat exchanger being arranged partially in the recirculation air duct and the fresh air duct; wherein the heating, ventilation, air conditioning device includes an inner mixing door configured to control flow of air between the recirculation air duct and the fresh air duct, wherein the fresh air duct includes a cabin outlet mouth leading to a cabin panel nozzle and a defrost outlet mouth leading to a defrost nozzle, wherein the recirculation air duct includes a floor outlet mouth leading to a floor nozzle, wherein the heating, ventilation, air conditioning device is intended to be mounted in a vehicle so that the recirculation air duct is arranged above the fresh air duct at the outlet portion of the blower.

In one example, the fresh air duct at least partially encircles the recirculation air duct.

In one example, the first heat exchanger is an evaporator.

In one example, the second heat exchanger is a radiator.

In one example, the recirculation air duct includes a first bypass path for the second heat exchanger.

In one example, the recirculation air duct includes a first mixing flap configured to control the amount of air travelling through the first bypass path.

In one example, the fresh air duct includes a second bypass path for the second heat exchanger.

In one example, the recirculation air duct includes a second mixing flap configured to control the amount of air travelling through the second bypass path.

In one example, the heating, ventilation, air conditioning device further comprises a first separation partition extending upstream of the first heat exchanger configured to separate the recirculation air duct and the fresh air duct.

In one example, the heating, ventilation, air conditioning device further comprises a second separation partition extending between the first heat exchanger and the second heat exchanger and configured to separate the recirculation air duct and the fresh air duct.

In one example, the heating, ventilation, air conditioning device further comprises a third separation partition extending downstream of the second heat exchanger and configured to separate the recirculation air duct and the fresh air duct.

In one example, the cabin outlet mouth is includes a slide door configured to control the amount of air travelling through the cabin outlet mouth.

In one example, the inner mixing door is a slide door.

In one example, blower includes a finned wheel with a first axial part and a second axial part, and a tubular component configured to demarcate the first air circulation channel allowing flow of air intended to pass through the first axial part and the second air circulation channel allowing flow of air intended to pass through a second axial part.

In one example, the tubular component is mounted at the first end of said finned wheel and demarcates an internal space forming at least one part of the first air circulation channel, with the second air circulation channel extending outside the tubular component.

In one example, the blower is arranged upstream of the recirculation air duct and the fresh air duct.

Another object of the invention is a motor vehicle comprising a cabin and a heating, ventilation, air conditioning device including: a fresh air inlet, a recirculation air inlet, a first air circulation channel, a second air circulation channel separated from the first air circulation channel, the first air circulation channel being configured to receive air from the fresh air inlet, and the second air circulation channel being configured to receive air from the recirculation air inlet, a blower with an inlet portion and an outlet portion, configured to induce airflow to and from the first air circulation channel and the second air circulation channel so that the fresh air and the recirculation air travel through the blower from the inlet portion to the outlet portion, a recirculation air duct connected to the second circulation channel, a fresh air duct separated from the recirculation air duct and connected to the first circulation channel, a first heat exchanger, a second heat exchanger, with both the first heat exchanger and the second heat exchanger being arranged partially in the recirculation air duct and the fresh air duct; wherein the heating, ventilation, air conditioning device includes an inner mixing door configured to control flow of air between the recirculation air duct and the fresh air duct, wherein the fresh air duct includes a cabin outlet mouth leading to a cabin panel nozzle and a defrost outlet mouth leading to a defrost nozzle, wherein the recirculation air duct includes a floor outlet mouth leading to a floor nozzle, wherein the heating, ventilation, air conditioning device is intended to be mounted in a vehicle so that the recirculation air duct is arranged above the fresh air duct at the outlet portion of the blower.

### BRIEF DESCRIPTION OF DRAWINGS

The present invention will be described in greater detail below with reference to the drawings. In the drawings:

FIG. 1 is a cross section of a profile view illustrating the heating, ventilation and/or air-conditioning device according to the invention in one mode of operation; and

FIG. 2 is a detailed drawing of FIG. 1 illustrating the heating, ventilation and/or air-conditioning device in another mode of operation.

### DETAILED DESCRIPTION

It is to be noted that, in the figures, the structural and/or functional elements common to the various embodiments can have the same reference signs. Thus, unless otherwise stated, such elements have identical structural, dimensional and material properties.

According to the present invention, the terms “downstream”, “upstream”, “in series” and “parallel” describe the position of one component in relation to another component, in the direction of flow of an air flow in a heating, ventilation and/or air conditioning device according to the present invention.

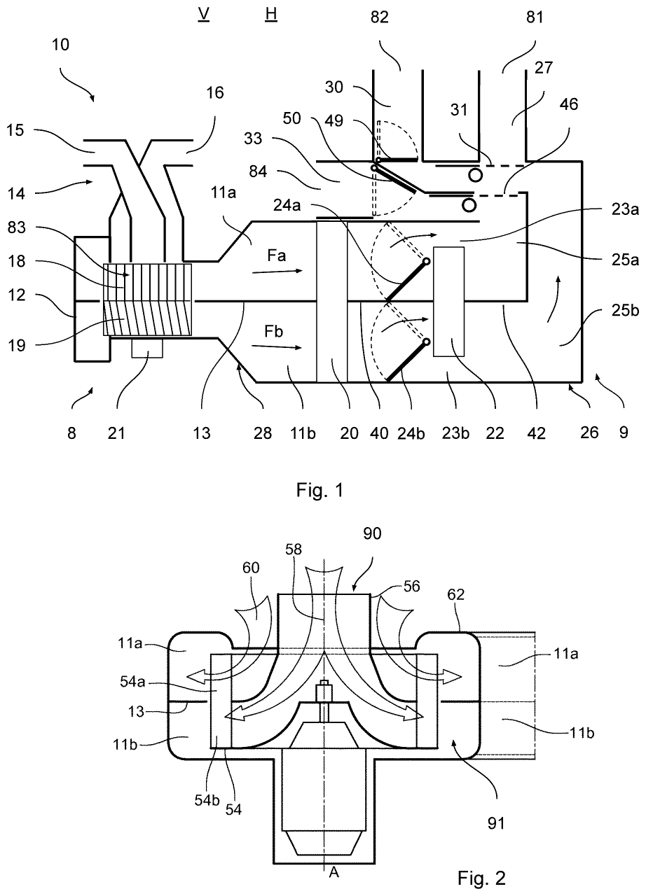

FIG. 1 illustrates a profile view of a heating, ventilation and/or air conditioning device 10 according to the invention comprising a housing 12 with at least one air inlet and one air outlet thus defining a duct, or flow duct, in which at least one air flow circulates. The housing 12 further comprises, inside its internal volume, a separation wall, or partition, 13 in order to define a recirculation air duct 11a for a first air flow Fa, in other words, in which a first air flow Fa flows that is intended to be thermally treated and to be sent into the cabin H of the vehicle V, and a fresh air duct 11b for a second air flow Fb, in other words, in which a second air flow Fb flows that is also intended to be thermally treated and to be sent into the cabin H of the vehicle V. The housing 12 incorporates the various elements of the device 10. In other words, the housing 12 comprises a recirculation air duct 11a so that a first air flow Fa can circulate inside this duct and the housing 12 comprises a fresh air duct 11b so that a second air flow Fb, distinct from the first air flow Fa, can circulate inside this duct, with the two flow ducts 11a, 11b being separated by a separation partition 13.

The device 10 comprises an air inlet housing 14 secured to the housing 12. The air inlet housing 14 comprises a fresh air inlet 15 for introducing a fresh air flow, in other words, an air flow originating from outside the vehicle V when the device 10 is installed in the vehicle V. The air inlet housing 14 further comprises a second air inlet, or mouth, 16 for introducing a recycling air flow, in other words, an air flow originating from the cabin H of the vehicle V.

The device 10 comprises a device able to blow the air, i.e. device conveying one or more air flows, commonly called a blower 83 (or motor-fan unit). The blower 83 comprises, for example, a first finned wheel 18 mounted in the recirculation air duct 11a and able to generate a first air flow Fa, and a second finned wheel 19 mounted in the fresh air duct 11b and able to generate a second air flow Fb, with these two wheels 18, 19 being able to be driven, individually or together, by an electric motor 21. The blower 83 includes an inlet portion 90, constituting is upstream section, and an outlet portion 91, constituting its downstream section.

The heating, ventilation and/or air conditioning device 10 further comprises heat exchangers for heating and/or cooling said air flow prior to its distribution inside the cabin H, according to the instructions from the occupants of the vehicle V. By way of an example, the thermal treatment devices, i.e. the heat exchangers, can comprise a first heat exchanger 20, which will be called the evaporator 20 hereafter, intended to cool and dehumidify the air flow passing therethrough, as well as a second heat exchanger 22, which will be called the radiator 22 hereafter, optionally connected to an additional electric radiator, intended to heat any air flow passing through one or both of them. As illustrated in FIG. 1, each heat exchanger 20, 22 is arranged in the recirculation air duct 11a and in the fresh air duct 11b, with each heat exchanger 20, 22 being common to the two flow ducts 11a, 11b. The device 10 further comprises a first bypass path 23a for the radiator 22 arranged in the recirculation air duct 11a and a second bypass path 23b for the radiator 22 arranged in the fresh air duct 11b.

A first mixing flap 24a is arranged in the recirculation air duct 11a. A second mixing flap 24b is arranged in the fresh air duct 11b. Each mixing flap 24a, 24b is able to transition from a configuration in which it shuts-off the bypass path 23a, 23b, as illustrated in FIG. 1, with the entirety of each air flow Fa, Fb then passing through the radiator 22, to a configuration in which it prevents the air flow Fa, Fb from passing through the radiator 22, with the entirety of each air flow Fa, Fb then passing through the bypass path 23a, 23b. Of course, each mixing flap 24a, 24b is able to adopt any intermediate position.

According to one embodiment, not shown, the heating, ventilation and/or air conditioning device can further comprise a bypass path for the evaporator arranged in each flow duct.

Each flow duct 11a, 11b further comprises a mixing zone 25a, 25b where the hot and cold air flows Fa, Fb that have respectively passed through the radiator 22 and/or the evaporator 20 are mixed in variable proportions, then routed toward the nozzles, or mouths, of outlets emerging in different zones of the cabin H.

The device 10 in this case comprises a cabin outlet mouth 27 and a defrost outlet mouth 30, with each being provided respectively with a cabin slide door 31 and a defrost shut-off flap 49 for shutting-off or not shutting-off said outlet mouths. The fresh air duct 11b for the second air flow Fb comprises the defrost outlet mouth 30, connected to the defrost shut-off flap 49, conveying the second air flow Fb toward the defrost nozzle 82, thus allowing the windshield to be demisted, and the cabin outlet mouth 27, connected to the cabin slide door 31, conveying the second air flow Fb toward the cabin panel nozzle 81, thus allowing the passengers of the vehicle V to be cooled/heated.

The recirculation air duct 11a includes a floor outlet mouth 33 leading to a floor nozzle 84. The floor nozzle 84 enables supplying the air to the floor region in a vehicle V. A floor shut-off flap 50 can be used to control the level of opening to the floor outlet mouth 33, e.g. by moving it between a completely closed position and a completely open position.

According to one embodiment, not shown, a possibility can be provided for thermally managing the various zones of the vehicle V in an independent manner, in particular for the top-of-the-range vehicles. To this end, the housing 12 can comprise an additional outlet mouth at a flow duct 11a, 11b intended to aerate other zones of the cabin H, such as the passengers in the rear of the vehicle V.

As previously established, the heating, ventilation and/or air conditioning device 10 can be fed either with fresh air or with recycling air. Depending on the operating conditions, it can be of particular interest to use fresh air so that it can be introduced into the cabin H at the defrost nozzle 82 located close to the windshield, after heating through the heating, ventilation and/or air conditioning device and, conversely, to use the recycling air in order to discharge it into the cabin H at the floor nozzle 84. In order to guarantee this separation between the outside and recycled air flow, whilst being able to select or adjust the type of air to be delivered as well as possible, at least one separation partition 13 is arranged inside the housing 12.

The two flow ducts 11a, 11b are separated by a first separation partition 13, in a zone located upstream, between and directly downstream of the finned wheels 18, 19. The first separation partition, or wall, 13 extends up to the first heat exchanger 20, more specifically, the first separation partition 13 comes close to the first heat exchanger 20, namely said separation partition 13 may or may not come into abutment against the evaporator 20. The device 10 can further comprise a second separation partition 40 arranged between the two heat exchangers 20, 22 and separating, or demarcating, the two flow ducts 11a, 11b from each other. Said separation partition 40 may or may not come into abutment against each heat exchanger 20, 22. The device 10 can further comprise a third separation partition 42 arranged downstream of the second heat exchanger 22 and separating, or demarcating, the two flow ducts 11a, 11b. An inner mixing door 46 can be arranged on one of said separation partitions 13, 40, 42 in order to allow an air flow Fa, Fb to transition from one flow duct 11a, 11b to another. As illustrated in FIG. 1, the inner mixing door 46 is mounted at the downstream end of the third separation partition 42. The inner mixing door 46 can be a slide door.

The portion of the housing 12 in which the second heat exchanger 22 and the outlet mouths 27, 30 are arranged is commonly called the distribution 26.

In general, the heating, ventilation, air conditioning device 10 is intended to be mounted in a vehicle V so that the recirculation air duct 11a is arranged above the fresh air duct 11b at the outlet portion 91 of the blower 83. In other words, when the HVAC is mounted in the vehicle as intended, the blower 83 is arranged so that the fresh air leaves the blower 83 at its lower portion 91, closer to the ground, compared with the recirculation air that leaves the blower 83 at its upper portion 90, closer to the top portion of the vehicle V. This can allow having the floor nozzle 84 positioned in a front upper portion of the distribution 26.

In one example, the fresh air duct 11b at least partially encircles the recirculation air duct 11a. For example, at some point the recirculation air duct 11a can be sandwiched between different sections of the fresh air duct 11b, as can be seen in FIG. 1.

The device 10 can comprise an air inlet housing 14 and the blower 83 (or motor-fan unit) as illustrated in FIG. 2, namely with a single turbine, in other words, a finned wheel 54 able to be rotated about an axis A. The device 10 comprises a tubular component 56 able to demarcate a first air circulation channel 58 allowing the flow of a first air flow intended to pass through a first axial part 54b and a second air circulation channel 60 allowing the flow of a second air flow intended to pass through a second axial part 54a. The first air circulation channel 58 is configured to receive air from the fresh air inlet 15, and the second air circulation channel 60 being configured to receive air from the recirculation air inlet 16. The tubular component 56 is mounted at the site of a first end of said finned wheel 54 and demarcates an internal space, or volume, forming at least one part of the first air circulation channel 58, with the second air circulation channel 60 extending outside the tubular component 56. The device 10 further comprises an air inlet housing 14 covering the first end of the finned wheel 54 and the tubular component 56. The air inlet housing 14 comprises guidance devices able to direct a first air flow into the first air circulation channel 58, and able to direct a second air flow into the second air circulation channel 60. The axial parts 54a, 54b can be made, for example, with reference to the vertical axis of the vehicle V, when the device 10 is installed in the vehicle V.

The blower 83 is configured to induce airflow to and from the first air circulation channel 58 and the second air circulation channel 60 so that the fresh air and the recirculation air travel through the blower 83 from the inlet portion 90 to the outlet portion 91.

To this end, the air inlet housing 14 can comprise, for example, the fresh air inlet 15 and the recirculation air inlet 16, one for the fresh air and one for the recycling air, and for example three drum flaps with coaxial axes of rotation. The central drum flap can be arranged to allow aeraulic communication between the air inlet mouths 15, 16 and the first air circulation channel 58. The two lateral drums can be arranged to allow aeraulic communication between the air inlet mouths 15, 16 and the second air circulation channel 60.

The finned wheel 54 is arranged in a blower housing 62, the outlet of which comprises the two flow ducts 11a, 11b separated by the partition wall 13. In other words, the first air circulation channel 58 orients the air flow toward a first axial part 54b and thus emerges in the fresh air duct 11b, whereas the second air circulation channel 60 orients the air flow toward the second axial part 54a of the finned wheel 54 and thus emerges in the recirculation air duct 11a. In other words, the recirculation air duct 11a is connected to the second circulation channel 60, and the fresh air duct 11b is separated from the recirculation air duct 11a and is connected to the first circulation channel 58.

The blower 83, i.e. the one or more finned wheels 18, 19, 54 is contained in a spiral shaped portion of the housing 12, commonly called blower housing 62. The air flows drawn in by the one or more finned wheels 18, 19, 54 are oriented toward the walls of the blower housing 62 and thus conform to the circular trajectory defined by these walls. The blower housing 62 has a radial evolution starting from a point, called tip, of the blower housing, over an angle range that is generally 360 degrees. The blower housing 62 subsequently has a blower housing outlet in the form of a straight duct so that the air flows exiting the blower housing 62 follow this same direction.

The part of the housing 12 positioned between the outlet of the blower housing 62 and the distribution 26 is commonly called the divergent 28. The divergent 28 corresponds to a channel, in which the air flow exiting the blower housing 62 is routed up to the first heat exchanger, in this case the evaporator 20. With the evaporator 20 generally being higher than the air blower and the blower housing 62, the divergent 28 has an extension, in relation to the blower housing 62, over its height and/or over its width.

As illustrated in FIG. 1, the heating, ventilation and/or air conditioning device 10 is separated, or demarcated, into two parts along an axis, which can be the vertical axis when the device 10 is installed in a motor vehicle V, to such an extent that a first module is distinguished, namely the inlet module 8. The inlet module 8 comprises the air inlet housing 14, therefore the air inlets 15, 16, the blower housing 62, the divergent 28 and the first heat exchanger 20, and therefore the part of the housing 12 supporting the evaporator 20. A second module is distinguished, namely the distribution module 9. For its part, the distribution module 9 comprises the distribution 26, namely the part of the housing 12 where the radiator 22 and the outlet mouths 27, 30 are arranged, as previously explained. According to a particular non-limiting embodiment, the inlet module 8 and the distribution module 9 are two distinct and separate sub-assemblies of the heating, ventilation and/or air conditioning device 10.

The invention is not limited to these precise embodiments in the sense that the distribution module 9 could also comprise the evaporator 20.

The inlet module 8 and the distribution module 9 can be assembled or fixed together in a detachable manner.

As illustrated in FIG. 1, the motor vehicle V comprises a cabin H. The cabin H corresponds to the part of the vehicle V where the driver and passengers are located.

According to another embodiment, not shown, the heating, ventilation and/or air conditioning device, in particular the housing, can comprise soundproofing elements or even an acoustic absorption elements. To this end, the housing can comprise a coating made of a porous material or of a woven or non-woven material made up of different fibers. The walls of the housing also can be made from these soundproofing materials.

According to another embodiment, not shown, the heating, ventilation and/or air conditioning device can further comprise a sensor for detecting particulate matter. Said sensor for detecting particulate matter comprises at least one first orifice defining a first air inlet for an air flow, called outside air flow, and a second orifice defining a second air inlet for an air flow, called recycling air flow, with said air inlet for the outside air flow and the inlet for the recycling air flow being separate from each other. Said sensor for detecting particulate matter can be arranged at the air inlet housing or even at the distribution.

The invention as described above is not limited to the devices and configurations exclusively described for a particular embodiment, and also applies to all combinations of these devices or configurations, as well as to equivalents and to any combination of such devices or configurations with the equivalents.

1. A heating, ventilation, air conditioning device comprising:
a fresh air inlet,
a recirculation air inlet,
a first air circulation channel,
a second air circulation channel separated from the first air circulation channel,
the first air circulation channel being configured to receive air from the fresh air inlet, and the second air circulation channel being configured to receive air from the recirculation air inlet,
a blower with an inlet portion and an outlet portion, configured to induce airflow to and from the first air circulation channel and the second air circulation channel so that the fresh air and the recirculation air travel through the blower from the inlet portion to the outlet portion,
a recirculation air duct connected to the second circulation channel,
a fresh air duct separated from the recirculation air duct and connected to the first circulation channel,
a first heat exchanger,
a second heat exchanger,
with both the first heat exchanger and the second heat exchanger being arranged partially in the recirculation air duct and the fresh air duct;
wherein the heating, ventilation, air conditioning device includes an inner mixing door configured to control flow of air between the recirculation air duct and the fresh air duct,
wherein the fresh air duct includes a cabin outlet mouth leading to a cabin panel nozzle and a defrost outlet mouth leading to a defrost nozzle,
wherein the recirculation air duct includes a floor outlet mouth leading to a floor nozzle,
wherein the heating, ventilation, air conditioning device is intended to be mounted in a vehicle so that the recirculation air duct is arranged above the fresh air duct at the outlet portion of the blower.

2. A heating, ventilation, air conditioning device according to claim 1, wherein the fresh air duct at least partially encircles the recirculation air duct.

3. A heating, ventilation, air conditioning device according to claim 1, wherein the first heat exchanger is an evaporator.

4. A heating, ventilation, air conditioning device according to claim 1, wherein the second heat exchanger is a radiator.

5. A heating, ventilation, air conditioning device according to claim 1, wherein the recirculation air duct includes a first bypass path for the second heat exchanger.

6. A heating, ventilation, air conditioning device according to claim 5, wherein the recirculation air duct includes a first mixing flap configured to control the amount of air travelling through the first bypass path.

7. A heating, ventilation, air conditioning device according to claim 1, wherein the fresh air duct includes a second bypass path for the second heat exchanger.

8. A heating, ventilation, air conditioning device according to claim 7, wherein the recirculation air duct includes a second mixing flap configured to control the amount of air travelling through the second bypass path.

9. A heating, ventilation, air conditioning device according to claim 1, further comprising a first separation partition extending upstream of the first heat exchanger configured to separate the recirculation air duct and the fresh air duct.

10. A heating, ventilation, air conditioning device according to claim 1, further comprising a second separation partition extending between the first heat exchanger and the second heat exchanger and configured to separate the recirculation air duct and the fresh air duct.

11. A heating, ventilation, air conditioning device according to claim 1, further comprising a third separation partition extending downstream of the second heat exchanger and configured to separate the recirculation air duct and the fresh air duct.

12. A heating, ventilation, air conditioning device according to claim 1, wherein the cabin outlet mouth is includes a cabin slide door configured to control the amount of air travelling through the cabin outlet mouth.

13. A heating, ventilation, air conditioning device according to claim 1, wherein the inner mixing door is a slide door.

14. A heating, ventilation, air conditioning device according to claim 1, wherein blower includes a finned wheel with a first axial part and a second axial part, and a tubular component configured to demarcate the first air circulation channel allowing flow of air intended to pass through the first axial part and the second air circulation channel allowing flow of air intended to pass through a second axial part.

15. A heating, ventilation, air conditioning device according to claim 14, wherein the tubular component is mounted at the first end of said finned wheel and demarcates an internal space forming at least one part of the first air circulation channel, with the second air circulation channel extending outside the tubular component.

16. A heating, ventilation, air conditioning device according to claim 1, wherein the blower is arranged upstream of the recirculation air duct and the fresh air duct.

17. A motor vehicle comprising a cabin and a heating, ventilation, air conditioning device including: a fresh air inlet, a recirculation air inlet, a first air circulation channel, a second air circulation channel separated from the first air circulation channel, the first air circulation channel being configured to receive air from the fresh air inlet, and the second air circulation channel being configured to receive air from the recirculation air inlet, a blower with an inlet portion and an outlet portion, configured to induce airflow to and from the first air circulation channel and the second air circulation channel so that the fresh air and the recirculation air travel through the blower from the inlet portion to the outlet portion, a recirculation air duct connected to the second circulation channel, a fresh air duct separated from the recirculation air duct and connected to the first circulation channel, a first heat exchanger, a second heat exchanger, with both the first heat exchanger and the second heat exchanger being arranged partially in the recirculation air duct and the fresh air duct; wherein the heating, ventilation, air conditioning device includes an inner mixing door configured to control flow of air between the recirculation air duct and the fresh air duct, wherein the fresh air duct includes a cabin outlet mouth leading to a cabin panel nozzle and a defrost outlet mouth leading to a defrost nozzle, wherein the recirculation air duct includes a floor outlet mouth leading to a floor nozzle, wherein the heating, ventilation, air conditioning device is intended to be mounted in a vehicle so that the recirculation air duct is arranged above the fresh air duct at the outlet portion of the blower.
